(19) United States
(12) Patent Application Publication
(10) Pub. No.: US 2023/0202051 A1
(43) Pub. Date: Jun. 29, 2023

(54) TRANSPORT DEVICE, TRANSPORT METHOD, PROGRAM, AND INFORMATION PROCESSING DEVICE

(71) Applicant: SONY GROUP CORPORATION, TOKYO (JP)

(72) Inventors: WILLIAM ALEXANDRE CONUS, TOKYO (JP); KAZUO HONGO, TOKYO (JP); YOSHIKAZU FURUYAMA, TOKYO (JP); YASUNORI KAWANAMI, TOKYO (JP); JUN ARAI, TOKYO (JP); ATSUSHI SUZUKI, TOKYO (JP)

(21) Appl. No.: 17/999,084

(22) PCT Filed: May 14, 2021
(86) PCT No.: PCT/JP2021/018334

§ 371 Date: Nov. 17, 2022

(30) Foreign Application Priority Data
May 27, 2020 (JP) 2020-091925

(51) Int. Cl. B25J 13/08; B25J 13/00; B25J 11/00

(52) U.S. Cl. CPC B25J 13/08; B25J 13/003; B25J 11/008

(57) ABSTRACT

The present technology relates to a transport device, a transport method, a program, and an information processing device that can prevent damage to the content of luggage during transportation.

The transport device includes a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage. The present technology can be applied to, for example, a robot that transports luggage.

### TECHNICAL FIELD

The present technology relates to transport devices, transport methods, programs, and information processing devices, and particularly, relates to transport devices, transport methods, programs, and information processing devices that can prevent damage to the content of luggage during transportation.

### BACKGROUND ART

Conventionally, it has been proposed to vibrate luggage so that a robot hand or the like can appropriately grip the luggage to estimate parameters such as the weight or the center of gravity of the luggage (see, for example, PTL 1).

### CITATION LIST

### Patent Literature

[PTL 1]

JP 2019-164111A

### SUMMARY

### Technical Problem

However, PTL 1 does not consider preventing damage to the content of the luggage during transportation.

The present technology was made in view of such a situation, and makes it possible to prevent damage to the content of the luggage during transportation.

### Solution to Problem

A transport device according to a first aspect of the present technology includes a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

A transport method according to a second aspect of the present technology allows a transport device to estimate luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

A program according to the second aspect of the present technology causes a computer to execute processing comprising: estimating luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

An information processing device according to the second aspect of the present technology includes a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

In the first aspect or the second aspect of the present technology, the luggage characteristics including at least one of the fragility of the content of the luggage and the packaging quality of the luggage are estimated based on at least one of the changes in the position of the center of gravity due to the movement of the luggage, the vibration characteristics of the luggage, and the characteristics of the sound generated from the luggage due to the movement of the luggage.

### BRIEF DESCRIPTION OF DRAWINGS

FIG. 1 is a block diagram showing an embodiment of an information processing system to which the present technology is applied.

FIG. 2 is a block diagram showing a functional configuration example of an information processing device.

FIG. 3 is a schematic diagram showing an exemplary configuration of the exterior appearance of a robot.

FIG. 4 is a schematic diagram showing an exemplary configuration of the exterior appearance of a robot.

FIG. 5 is a block diagram showing a functional configuration example of the robot.

FIG. 6 is a flowchart for describing a robot selection process.

FIG. 7 is a flowchart for describing a luggage transporting process.

FIG. 8 is a diagram showing an example of how the robot moves the body.

FIG. 9 is a diagram showing an example of how the robot moves the body.

FIG. 10 is a diagram showing an example of a method of estimating the packaging quality.

FIG. 11 is a graph showing an example of luggage vibration characteristics or characteristics of generated sound.

FIG. 12 is a graph showing an example of luggage vibration characteristics or characteristics of generated sound.

FIG. 13 is a diagram showing an example of the installation positions of microphones.

FIG. 14 is a diagram showing an example of a position of a sound source of generated sound and a transport method.

FIG. 15 is a diagram showing an example of a position of a sound source of generated sound and a transport method.

FIG. 16 is a diagram showing an example of a position of a sound source of generated sound and a transport method.

FIG. 17 is a diagram showing an example of a position of a sound source of generated sound and a transport method.

### DESCRIPTION OF EMBODIMENTS

Modes for carrying out the present technology (hereinafter also referred to as “embodiments”) will be described below.

Description will be given in the following order.

1. Embodiment

2. Modification Examples

3. Others

### 1. Embodiment

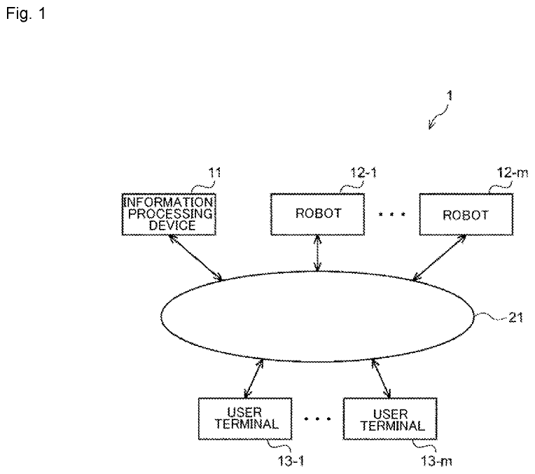

Embodiments of the present technology will be described with reference to FIGS. 1 to 17.

### <Exemplary Configuration of Information Processing System 1>

FIG. 1 shows a configuration example of an information processing system 1 to which the present technology is applied.

The information processing system 1 includes an information processing device 11, robots 12-1 to 12-m, and user terminals 13-1 to 13-n. The information processing system 1 is a system that provides a service (hereinafter referred to as a transportation service) in which the robots 12-1 to 12-m transport luggage in response to a request from a user.

In the present specification, the transportation of luggage is not limited to the case where the subject transporting the luggage (for example, the robot 12-1 to robot 12-m) moves with the luggage, for example, but includes a case where the subject transporting the luggage moves the luggage while the subject is stopped.

The information processing device 11, the robots 12-1 to 12-m, and the user terminals 13-1 to 13-n are connected to each other via the network 21 and communicate with each other. It should be noted that, for example, the information processing device 11 and the robots 12-1 to 12-m can directly communicate with each other without the network 21.

Hereinafter, when it is not necessary to individually distinguish the robots 12-1 to 12-m, they are simply referred to as the robot 12. Hereinafter, when it is not necessary to individually distinguish the user terminals 13-1 to 13-n, they are simply referred to as the user terminal 13.

The information processing device 11 is owned by, for example, a provider who provides a transportation service, and is configured of a server, a PC (personal computer), and the like. For example, the information processing device 11 receives transportation request information for requesting the transportation of the luggage from the user terminal 13 via the network 21. The information processing device 11 estimates the characteristics of the luggage to be transported (hereinafter referred to as luggage characteristics) based on the luggage information included in the transportation request information, and selects the robot 12 for transporting the luggage based on the luggage characteristics. The information processing device 11 transmits the transportation request information to the selected robot 12 via the network 21 or not via the network 21.

The robot 12 is an autonomous moving body that transports luggage based on the transportation request information. At this time, the robot 12 sets a method of transporting the luggage based on the luggage characteristics. The robot 12 updates the luggage characteristics as appropriate based on, for example, the state of the luggage when the luggage is moved and the movement of the user when the luggage is handed over to the robot 12, and changes the luggage transport method based on the updated luggage characteristics if necessary.

The user terminal 13 is, for example, an information processing device owned by a user who uses a transportation service, and is configured of a PC, a smartphone, a mobile phone, a tablet terminal, and the like. The user terminal 13 transmits the transportation request information input by the user to the information processing device 11 via the network 21.

### <Configuration Example of Information Processing Device 11>

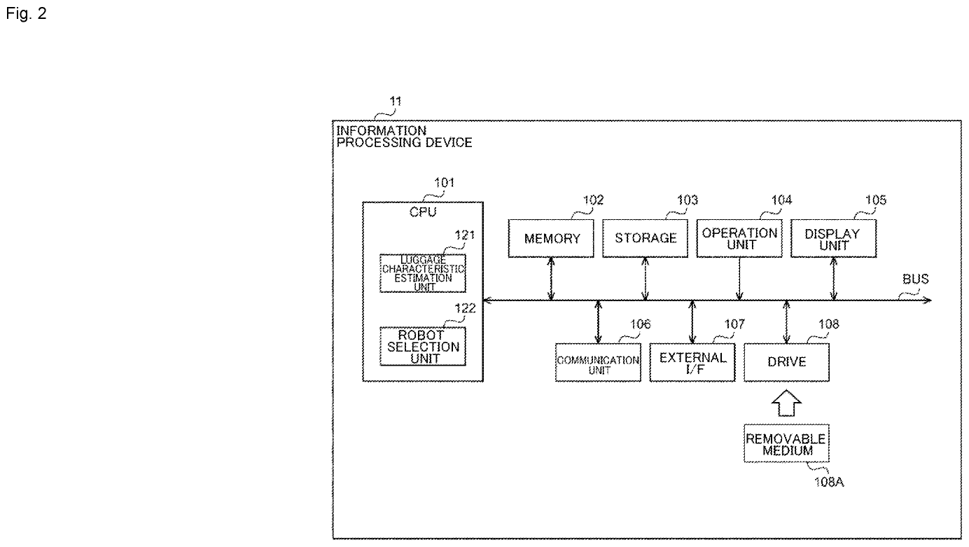

FIG. 2 is a block diagram illustrating a functional configuration example of the information processing device 11 of FIG. 1.

The information processing device 11 includes a CPU (Central Processing Unit) 101, a memory 102, a storage 103, an operation unit 104, a display unit 105, a communication unit 106, an external I/F 107, and a drive 108. The CPU 101 to the drive 108 are connected to a bus and perform necessary communication with each other.

The CPU 101 performs various processes by executing a program installed in the memory 102 or the storage 103.

The memory 102 is configured of, for example, a volatile memory or the like, and temporarily stores a program executed by the CPU 101 and necessary data.

The storage 103 is configured of, for example, a hard disk or a non-volatile memory, and stores a program executed by the CPU 101 and necessary data.

The operation unit 104 is configured of physical keys (including a keyboard), a mouse, a touch panel, and the like. The operation unit 104 outputs an operation signal corresponding to the operation of the user to the bus in response to the operation of the user.

The display unit 105 is configured of, for example, an LCD (Liquid Crystal Display) or the like, and displays an image according to the data supplied from the bus.

Here, for example, a touch panel as the operation unit 104 is configured of a transparent member and can be integrally configured with the display unit 105. As a result, the user can input information in a form of operating an icon, a button, or the like displayed on the display unit 105.

The communication unit 106 includes a communication circuit, an antenna, and the like, and communicates with the robot 12, the user terminal 13, and the like via the network 21 or without the network 21.

The external I/F (interface) 107 is an interface for exchanging data with various external devices.

The drive 108 is configured such that a removable medium 108A such as a memory card can be attached thereto and detached therefrom, and drives the removable medium 108A mounted therein.

In the information processing device 11 configured as described above, the program executed by the CPU 101 can be recorded in advance in the storage 103 as a recording medium built in the CPU 101.

Further, the program can be stored (recorded) in the removable medium 108A, provided as so-called package software, and installed in the information processing device 11 from the removable medium 108A.

In addition, the program can be downloaded from a server or the like (not shown) and installed in the information processing device 11 via the network 21 and the communication unit 106.

The CPU 101 can function as a luggage characteristic estimation unit 121 and a robot selection unit 122 by executing a program installed in the information processing device 11.

The luggage characteristic estimation unit 121 estimates the luggage characteristics based on the luggage information included in the transportation request information received from the user terminal 13.

The robot selection unit 122 selects the robot 12 that transports the luggage based on the estimated luggage characteristics. The robot selection unit 122 transmits the transportation request information to the selected robot 12 via the communication unit 106.

### <Configuration Example of Robot 12>

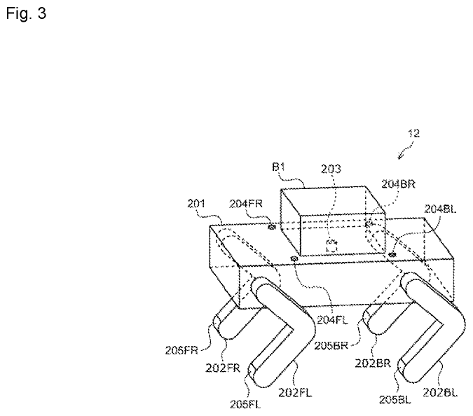

Next, an exemplary configuration of the robot 12 will be described with reference to FIGS. 3 to 5.

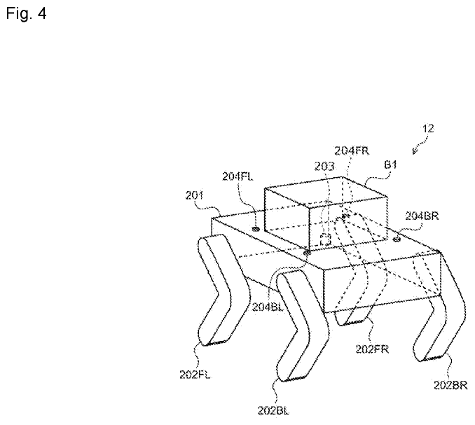

FIGS. 3 and 4 are schematic views showing an exemplary configuration of the appearance of the robot 12. FIG. 3 is a view of the robot 12 viewed from the left side, and FIG. 4 is a view of the robot 12 viewed from diagonally rear left.

The robot 12 includes a body 201 and legs 202FL to 202BR.

The body 201 is a rectangular cuboid and has a flat upper surface. Then, luggage B1 is placed on the upper surface of the body 201.

The leg 202FL is attached to the front of the left side surface of the body 201, and the leg 202BL is attached to the rear. The leg 202FR is attached to the front of the right side surface of the body 201, and the leg 202BR is attached to the rear. Then, the robot 12 autonomously moves with the four legs 202FL to 202BR to transport the luggage B1.

An acceleration sensor 203 and microphones 204FL to 204BR are provided on the upper surface of the body 201. The acceleration sensor 203 is arranged near the center of the space in which the luggage B1 is placed (hereinafter referred to as a luggage space), and is used for detecting the vibration of the luggage B1, for example. The microphones 204FL to 204BR are arranged near the four corners of the luggage space, and are used for estimating the sound emitted from the luggage B1 (hereinafter referred to as the generated sound) and the position of the sound source of the generated sound.

Force sensors 205FL to 205BR are provided near the distal ends of the front surfaces of the legs 202FL to 202BR, respectively. The force sensors 205FL to 205BR are used for detecting the position of the center of gravity of the luggage B1, for example.

Hereinafter, when it is not necessary to individually distinguish the legs 202FL to 202BR, they are simply referred to as the leg 202. Hereinafter, when it is not necessary to individually distinguish the microphones 204FL to 204BR, they are simply referred to as the microphone 204. Hereinafter, when it is not necessary to individually distinguish the force sensors 205FL to 205BR, they are simply referred to as the force sensor 205.

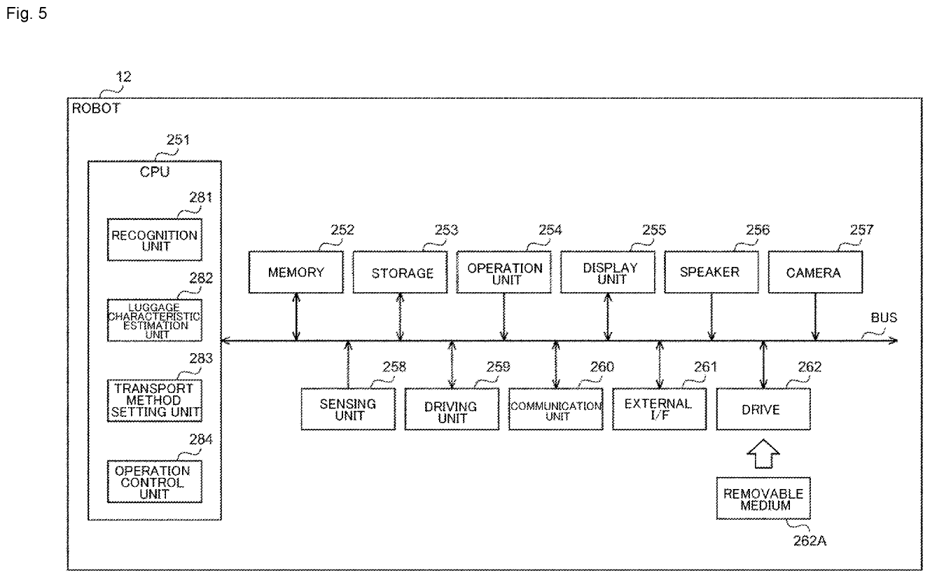

FIG. 5 is a block diagram showing a functional configuration example of the robot 12.

The robot 12 includes a CPU 251, a memory 252, a storage 253, an operation unit 254, a display unit 255, a speaker 256, a camera 257, a sensing unit 258, a drive unit 259, a communication unit 260, an external I/F 261, and a drive 262. The CPU 251 to the drive 262 are connected to the bus and perform necessary communication with each other.

The CPU 251 to the display unit 255 and the communication unit 260 to the drive 262 are configured in the same manner as the CPU 101 to the display unit 105 and the communication unit 106 to the drive 108 in FIG. 2, respectively.

The speaker 256 outputs sound according to the data supplied from the bus.

The camera 257 captures an image (still image, moving image) (senses light) and outputs the corresponding image data to the bus.

The sensing unit 258 includes various sensors such as the acceleration sensor 203, the microphone 204, and the force sensor 205 of FIGS. 3 and 4, and outputs the sensor data output from each sensor onto the bus.

The drive unit 259 includes, for example, a drive mechanism (for example, an actuator or the like) for driving a movable unit such as the leg 202 of the robot 12.

In the robot 12, similarly to the information processing device 11, the program executed by the CPU 251 can be recorded in advance in the storage 253 as a recording medium built in the robot 12.

Further, the program can be stored (recorded) in the removable medium 262A, provided as package software, and installed on the robot 12 from the removable medium 262A.

In addition, the program can be downloaded from a server or the like (not shown) and installed on the robot 12 via the network 21 and the communication unit 260.

The CPU 251 can function as a recognition unit 281, a luggage characteristic estimation unit 282, a transport method setting unit 283, and an operation control unit 284 by executing the program installed in the robot 12.

The recognition unit 281 recognizes the state of the robot 12 and the surrounding situation of the robot 12 based on, for example, the image data supplied from the camera 257 and the sensor data supplied from the sensing unit 258. For example, the recognition unit 281 recognizes the movement of the user who requests the robot 12 to transport the luggage.

The luggage characteristic estimation unit 282 estimates the luggage characteristics of the luggage to be transported based on at least one of the luggage information included in the transportation request information received from the information processing device 11, the image data supplied from the camera 257, the sensor data supplied from the sensing unit 258, and the recognition result of the user's movement. The luggage characteristic estimation unit 282 gives an instruction regarding the operation of the robot 12 to the operation control unit 284 when the luggage B1 is moved to estimate the luggage characteristics.

The transport method setting unit 283 sets the luggage transport method based on the estimated luggage characteristics and the like.

The operation control unit 284 controls the operation of the robot 12 by controlling the drive unit 259 based on the set transport method or the like.

The exemplary configuration of the robot 12 described above is an example thereof, and can be appropriately changed. For example, the structure, size, shape, movement, luggage transport method, and the like of the robot 12 can be appropriately changed. Specifically, the robot 12 may be made to walk on two legs or run on wheels. For example, the robot 12 may transport the luggage in a hand, transport the luggage on its back, or store the luggage in a box-shaped luggage space.

Further, not all robots 12 need to have the same characteristics, and robots 12 having different characteristics may be mixed. Here, the characteristics of the robot 12 are, for example, the structure, size, shape, movement, luggage transport method, and ability (for example, maximum speed, maximum moving distance, maximum luggage capacity, and the like) of the robot 12.

Hereinafter, an example in which robots 12 having different characteristics are mixed in the information processing system 1 and the robots 12 shown in FIGS. 3 to 5 transport luggage will be described.

### <Processing of Information Processing System 1>

Next, processing of the information processing system 1 will be described.

### <Robot Selection Process>

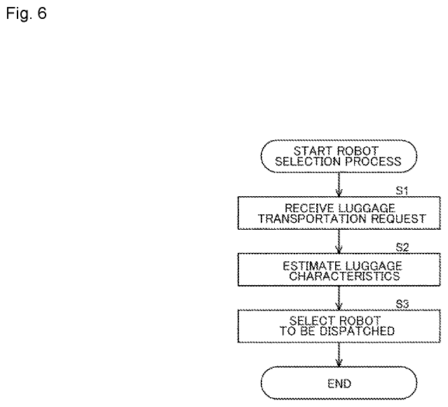

First, the robot selection process executed by the information processing device 11 will be described with reference to the flowchart of FIG. 6.

In step S1, the luggage characteristic estimation unit 121 receives a request for transporting the luggage.

Specifically, for example, the user inputs the transportation request information into the user terminal 13 in order to request the transportation of the luggage.

The transportation request information includes, for example, a place from which the luggage is delivered, a destination (a place to which the luggage is delivered), a date and time when the luggage is delivered to the destination (hereinafter referred to as a delivery date and time), and luggage information related to the luggage to be transported.

The luggage information includes, for example, at least one of the characteristics of the content of the luggage and the characteristics of the luggage after packaging.

The characteristics of the content of the luggage include, for example, at least one of the type, quantity, weight, volume, shape, material, fragility, precautions, and the like of the article constituting the content of the luggage. Precautions regarding the content of luggage include, for example, precautions such as breakable items, flammable items, and fragile items.

The characteristics of the luggage after packaging include, for example, at least one of the quantity, weight, volume, shape, precautions, packaging method, and the like of the luggage in the packaged state. Precautions regarding the luggage after packaging include, for example, precautions regarding the handling of the luggage after packaging. Specifically, the precautions regarding the luggage after packaging include precautions such as the need for horizontal placement.

The user terminal 13 transmits the transportation request information to the information processing device 11 via the network 21.

On the other hand, the luggage characteristic estimation unit 121 of the information processing device 11 receives the transportation request information via the communication unit 106.

In step S2, the luggage characteristic estimation unit 121 estimates the luggage characteristics. Specifically, the luggage characteristic estimation unit 121 estimates at least one of the fragility of the content of the luggage and the packaging quality based on the luggage information included in the transportation request information. For example, the luggage characteristic estimation unit 121 calculates a coefficient indicating the level of fragility of the content of the luggage (hereinafter referred to as a fragility coefficient) and a coefficient indicating the level of the packaging quality (hereinafter referred to as a packaging quality coefficient) according to a predetermined standard.

The fragility coefficient increases as the content of the luggage is more fragile, and decreases as the content of the luggage is less fragile. The packaging quality coefficient increases as the packaging quality increases, and decreases as the packaging quality decreases.

At this time, when the amount of information included in the luggage information is insufficient or the reliability of the luggage information is low, the luggage characteristic estimation unit 121 estimates the luggage characteristics while appropriately supplementing or predicting the information.

Here, an example of a method for estimating luggage characteristics will be described.

For example, it is assumed based on the luggage information that the content of the luggage includes one glass plate of 100 mm in length×100 mm in width×5 mm in thickness, and two boxes of box-shaped tissue paper of 200 mm in length×100 mm in width×50 mm in thickness. Further, it is assumed to be known that the content of the luggage is packaged by a cardboard box, and the volume of the cardboard box is 4,000,000 mm³.

For example, a fragility coefficient is set in advance for the type or content of each article. For example, the fragility coefficient for glass is set to 0.9 and the fragility coefficient for box-shaped tissue paper is set to 0.2. In addition, a fragility coefficient is set in advance for the shape of the article. For example, the fragility coefficient of a plate-shaped article is set to 0.7, and the fragility coefficient of a rectangular cuboid (box type) article is set to 0.3.

The luggage characteristic estimation unit 121 calculates the fragility coefficient of each article based on the two types of fragility coefficients. For example, the fragility coefficient of the glass plate is 0.9×0.7=0.63. For example, the fragility coefficient of box-shaped tissue paper is 0.2×0.3=0.06.

Next, the luggage characteristic estimation unit 121 calculates the ratio between the volume of the content of the luggage and the volume of the packaging material for packaging the luggage (hereinafter referred to as the luggage occupancy rate). In the case of this example, the volume of the content of the luggage is the sum of the volume of the glass plate and the volume of the box-shaped tissue paper. Specifically, the volume of the glass plate is 100×100×5=50,000 mm³, and the volume of the box-shaped tissue paper is 200×100×50×2=2,000,000 mm³. Therefore, the luggage occupancy rate is (50,000+2,000,000)/4,000,000≈0.51.

Here, for example, it is estimated that the larger the value of the luggage occupancy rate, the smaller the space for inserting a cushioning material or the like for preventing damage to the content of the luggage, so that the content of the luggage become more fragile.

Next, the luggage characteristic estimation unit 121 calculates the final fragility coefficient of the luggage by the product of the maximum value of the fragility coefficient of each article and the luggage occupancy rate. In the case of this example, the fragility coefficient of the luggage is 0.32, which is the product of the fragility coefficient of the glass plate of 0.63 and the luggage occupancy rate of 0.51.

This is an example of a method for calculating the fragility coefficient, and can be changed as appropriate. For example, the method of expressing the fragility coefficient can be changed as appropriate. For example, the fragility coefficient may be expressed as a predetermined number of steps (for example, 10 steps) of level.

The luggage characteristic estimation unit 121 adds the luggage characteristic information indicating the estimation result of the luggage characteristics (fragility coefficient and the packaging quality coefficient) to the luggage information included in the transportation request information.

In step S3, the robot selection unit 122 selects the robot 12 to be dispatched based on the luggage information. For example, the robot selection unit 122 selects the robot 12 suitable for transporting the requested luggage based on at least one of the characteristics of the content of the luggage included in the luggage information, the characteristics of the luggage after packaging, the fragility coefficient, and the packaging quality coefficient, the characteristics of each robot 12, and other conditions such as the delivery date and time and the charge.

The robot selection unit 122 transmits the transportation request information to the selected robot 12 via the communication unit 106.

On the other hand, the communication unit 260 of the selected robot 12 receives the transportation request information via the network 21 or without the network 21. The communication unit 260 supplies the received transportation request information to the CPU 251.

### <Luggage Transport Process>

Next, the luggage transport process executed by the robot 12 that has received the request for luggage transportation will be described.

In step S51, the robot 12 moves to the luggage delivery place. For example, the operation control unit 284 controls the drive unit 259 to move the robot 12 to the delivery place indicated in the transportation request information.

In step S52, the robot 12 updates the luggage characteristics based on the movement of the user when handing the luggage over to the robot 12.

For example, the robot 12 arriving at the delivery place receives the luggage to be transported from the user. At this time, the camera 257 takes a picture of the user and supplies the obtained image data to the recognition unit 281.

The recognition unit 281 recognizes the movement of the user when handing the luggage over to the robot 12, that is, the movement of the user when handling the luggage, based on the image data. The luggage characteristic estimation unit 282 updates the luggage characteristic information (fragility coefficient and packaging quality coefficient) included in the transportation request information as necessary based on the recognition result of the user's movement.

For example, when handling luggage whose content is fragile, the user is expected to perform the following movements.
Move while paying attention to surrounding obstacles.
Keep an eye on luggage.
Do not move luggage suddenly, place it suddenly, or vibrate it. In other words, large accelerations or vibrations are not applied to luggage.
Be careful not to drop luggage.
Transport luggage separately. Avoid stacking luggage.
Do not put heavy objects on luggage.

For example, the luggage characteristic estimation unit 282 updates the fragility coefficient based on the presence and degree of movement of the user.

In step S53, the robot 12 updates the luggage characteristics by moving the luggage.

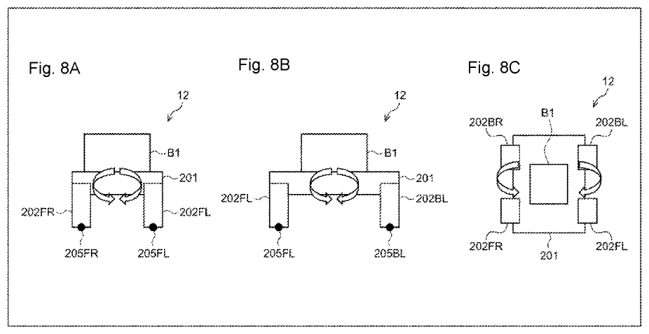

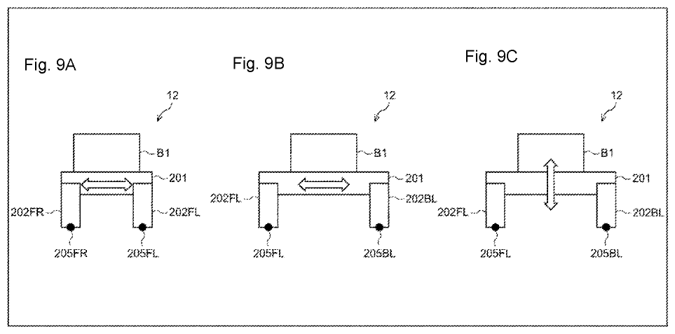

For example, the operation control unit 284 controls the drive unit 259 according to an instruction of the luggage characteristic estimation unit 282 to move the body 201 as shown in FIGS. 8 and 9 to thereby move the luggage B1 placed on the body 201.

A in FIG. 8 is a front view of the robot 12, and shows an example of moving (tilting to the left and right) the body 201 around the roll axis. B in FIG. 8 is a left side view of the robot 12, and shows an example of moving (tilting back and forth) the body 201 around the pitch axis. C in FIG. 8 is a plan view of the robot 12, and shows an example of moving (twisting to the left and right) the body 201 around the yaw axis.

A in FIG. 9 is a front view of the robot 12, and shows an example of moving (swinging to the left and right) the body 201 in the left-right direction. B in FIG. 9 is a front view of the robot 12, and shows an example of moving (swinging back and forth) the body 201 in the front-rear direction. C in FIG. 9 is a left side view of the robot 12, and shows an example of moving (swinging up and down) the body 201 in the vertical direction.

For example, the operation control unit 284 controls the drive unit 259 according to an instruction of the luggage characteristic estimation unit 282 to move the body 201 according to one of the movements of A to C in FIG. 8 and A to C in FIG. 9 or a combination of two or more of the movements to thereby move the luggage B1. Then, the luggage characteristic estimation unit 282 detects a change in the position of the center of gravity due to the movement of the luggage B1, the vibration characteristics of the luggage B1, and the characteristics of the generated sound generated due to the movement of the luggage B1 based on the image data from the camera 257 and the sensor data from the sensing unit 258.

The operation control unit 284 controls the movement of the body 201 so that the content of the luggage B1 is not damaged, for example, at least one of the speed, strength, and magnitude of moving the luggage B1 is gradually increased.

For example, the luggage characteristic estimation unit 282 detects the amount of change in the position of the center of gravity of the luggage B1 based on the sensor data supplied from each force sensor 205 when the luggage B1 is tilted.

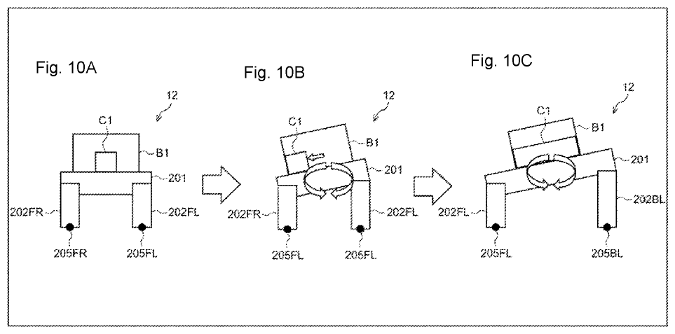

For example, FIG. 10 shows an example in which the content C1 of the luggage B1 is a rectangular cuboid and is not firmly fixed in the box of the rectangular cuboid. In this example, the width in the left-right direction and the height in the up-down direction of the content C1 are smaller than the width and height of the box. The depth of the content C1 in the front-rear direction is almost the same as the depth of the box.

For example, when the body 201 of the robot 12 is tilted around the roll axis as shown in B of FIG. 10 from the state of being kept horizontal as shown in A of FIG. 10, the content C1 moves a lot inside the box in a tilted direction. Therefore, the position of the center of gravity of the luggage B1 changes significantly. On the other hand, when the body 201 of the robot 12 is tilted around the pitch axis as shown in C of FIG. 10, the depth of the box and the depth of the content C1 are substantially the same, so that the content C1 hardly move in the box. Therefore, the position of the center of gravity of the luggage B1 hardly changes.

Therefore, the packaging quality of the luggage B1 can be estimated based on the amount of change in the position of the center of gravity when the body 201 (the luggage B1) is tilted. For example, it is estimated that the larger the amount of change in the position of the center of gravity, the easier it is for the content C1 to move, and the lower the packaging quality. On the other hand, it is estimated that the smaller the amount of change in the position of the center of gravity, the more difficult it is for the content C1 to move, and the higher the packaging quality.

For example, the luggage characteristic estimation unit 282 updates the luggage quality coefficient based on the detected amount of change in the position of the center of gravity. Specifically, for example, the luggage characteristic estimation unit 282 sets the maximum value of the amount of change in the position of the center of gravity based on the size of the packaging material (for example, a box) of the luggage. Next, the luggage characteristic estimation unit 282 divides the range of the amount of change in the position of the center of gravity (range from 0 to the maximum value) into a plurality of sections (for example, 10 sections). Then, the luggage characteristic estimation unit 282 sets the packaging quality coefficient based on which section the detected amount of change in the position of the center of gravity falls into.

As shown in the example of FIG. 10, the amount of movement of the content of the luggage changes depending on the direction in which the luggage is tilted. Therefore, the packaging quality coefficient may be set for each direction in which the luggage is tilted.

For example, the luggage characteristic estimation unit 282 detects the vibration characteristic of the luggage B1 based on the sensor data supplied from the acceleration sensor 203 when the luggage B1 is vibrated.

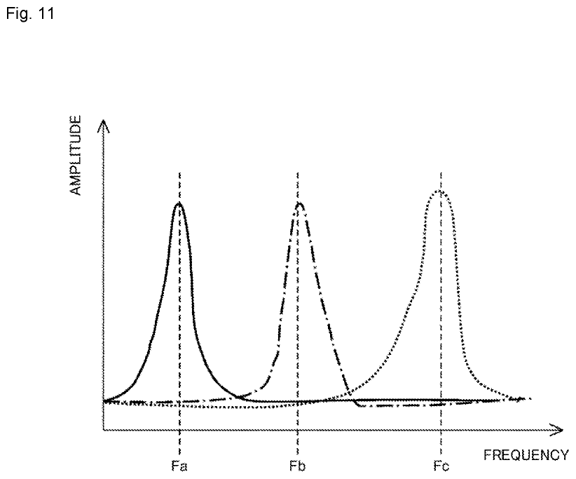

FIG. 11 is a graph showing an example of vibration characteristics of the luggage Ba to Bc when vibrations of the same amplitude and frequency are applied to the luggage Ba to Bc having different contents. The horizontal axis shows the frequency, and the vertical axis shows the amplitude. The frequencies at which the vibration amplitudes of the luggage Ba, Bb, and Bc peak are Fa, Fb, and Fc, respectively, and the frequency Fa<frequency Fb<frequency Fc.

Here, it is estimated that the more fragile the content of the luggage, the higher the frequency of vibration of the luggage. Therefore, in this case, it is estimated that the content of the luggage Bc is the most fragile and the content of the luggage Ba is the least fragile.

Therefore, for example, the luggage characteristic estimation unit 282 updates the fragility coefficient based on the frequency of the vibration of the luggage. For example, the higher the frequency, the higher the fragility coefficient, and the lower the frequency, the lower the fragility coefficient.

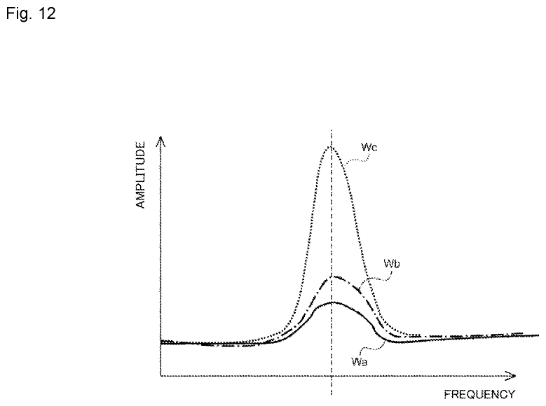

FIG. 12 is a graph showing an example of vibration characteristics of the luggage Ba to Bc when the same content are packaged by different methods and the vibrations of the same amplitude and frequency are applied to the luggage Ba to Bc. The horizontal axis shows the frequency, and the vertical axis shows the amplitude. The waveforms Wa, Wb, and We indicate the vibration waveforms of the luggage Ba, Bb, and Bc, respectively.

Here, it is estimated that the easier for the content of the luggage to move, the larger the amplitude of the vibration of the luggage, and the longer the duration of the vibration of the luggage. Therefore, in this case, it is estimated that the packaging quality of the luggage Bc is the worst and the packaging quality of the luggage Ba is the best.

Therefore, for example, the luggage characteristic estimation unit 282 updates the packaging quality coefficient based on the amplitude of the vibration of the luggage. For example, the larger the amplitude, the smaller the packaging quality coefficient, and the lower the amplitude, the larger the packaging quality coefficient.

For example, the luggage characteristic estimation unit 282 may update the packaging quality coefficient based on the duration of the vibration of the luggage instead of the amplitude of the vibration of the luggage. For example, the longer the duration of vibration, the smaller the packaging quality coefficient, and the shorter the duration of vibration, the larger the packaging quality coefficient.

For example, the luggage characteristic estimation unit 282 may update the fragility coefficient and the packaging quality coefficient by combining two or more of the frequency, amplitude, and duration of the vibration of the luggage.

For example, the luggage characteristic estimation unit 282 detects the resonance frequency of the luggage as the vibration characteristics of the luggage. Then, the luggage characteristic estimation unit 282 adds the detected resonance frequency to the luggage characteristic information.

For example, the luggage characteristic estimation unit 282 collects the generated sound emitted when the luggage is moved by each microphone 204, and detects the characteristics of the generated sound based on the sound data supplied from each microphone 204.

Hereinafter, the graphs of FIGS. 11 and 12 described above will be described by replacing them with graphs showing the characteristics of the generated sound.

FIG. 11 is a graph showing an example of the characteristics of the generated sound of the luggage Ba to Bc when vibrations of the same amplitude and frequency are applied to the luggage Ba to Bc having different contents. The frequencies at which the generated sounds of the luggage Ba, Bb, and Bc peak are Fa, Fb, and Fc, respectively, and the frequency Fa<frequency Fb<frequency Fc.

Here, for example, it is estimated that the more fragile the content of the luggage, the higher the frequency of the generated sound. Therefore, it is estimated that the higher the frequency of the generated sound, the more fragile the content of the luggage. In this case, it is estimated that the content of the luggage Bc is the most fragile and the content of the luggage Ba is the least fragile.

Therefore, for example, the luggage characteristic estimation unit 282 updates the fragility coefficient based on the frequency of the generated sound. For example, the higher the frequency, the higher the fragility coefficient, and the lower the frequency, the lower the fragility coefficient.

FIG. 12 is a graph showing an example of the characteristics of the generated sound of the luggage Ba to Bc when the same content is packaged by different methods and the vibrations of the same amplitude and frequency are applied to the luggage Ba to Bc. The horizontal axis shows the frequency, and the vertical axis shows the amplitude. The waveforms Wa, Wb, and We indicate the waveforms of the sounds generated by the luggage Ba, Bb, and Bc, respectively.

Here, it is estimated that the easier for the content of the luggage to move, the larger the amplitude (volume) of the generated sound, and the longer the duration of the generated sound. Therefore, in this case, it is estimated that the packaging quality of the luggage Bc is the worst and the packaging quality of the luggage Ba is the best.

Therefore, for example, the luggage characteristic estimation unit 282 updates the luggage quality coefficient based on the amplitude of the generated sound. For example, the larger the amplitude, the smaller the packaging quality coefficient, and the lower the amplitude, the larger the packaging quality coefficient.

For example, the luggage characteristic estimation unit 282 may update the packaging quality coefficient based on the duration of the generated sound instead of the amplitude of the generated sound. For example, the longer the duration of the generated sound, the smaller the packaging quality coefficient, and the shorter the duration of the generated sound, the larger the packaging quality coefficient.

For example, the luggage characteristic estimation unit 282 may update the fragility coefficient and the packaging quality coefficient by combining two or more of the frequency, amplitude, and duration of the generated sound.

For example, the luggage characteristic estimation unit 282 estimates the position of the sound source of the generated sound as the characteristics of the generated sound based on the time difference in the timing at which each microphone 204 detects the generated sound. For example, the luggage characteristic estimation unit 282 detects a time difference (hereinafter, referred to as a generated sound output time difference) from the time the luggage is moved until the sound data indicating the generated sound is output from each microphone 204. Then, the luggage characteristic estimation unit 282 estimates the position of the sound source of the generated sound in the luggage based on the generated sound output time difference.

For example, if there is a time lag between the time when the luggage characteristic estimation unit 282 gives an instruction to move the body 201 and the time when the body 201 actually starts to move, it is desirable that the time lag is subtracted and the generated sound output time difference is detected.

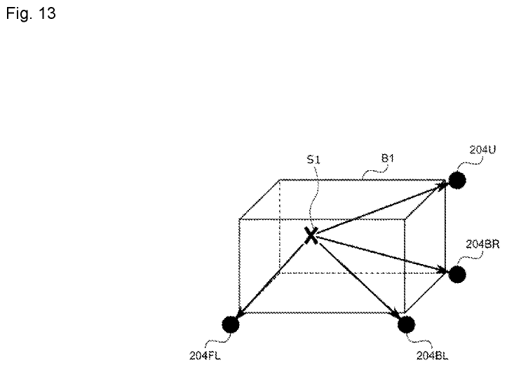

In order to estimate the position of the sound source of the generated sound, three or more microphones 204 that are not arranged in the same straight line are required. For example, as shown in FIG. 13, in addition to the microphones 204FL to 204BR (the microphone 204FR is not shown) installed in the same plane, a microphone 204U may be installed above the luggage B1 to improve the estimation accuracy of the position of the sound source S1.

The luggage characteristic estimation unit 282 adds the position of the sound source of the estimated generated sound to the luggage characteristic information.

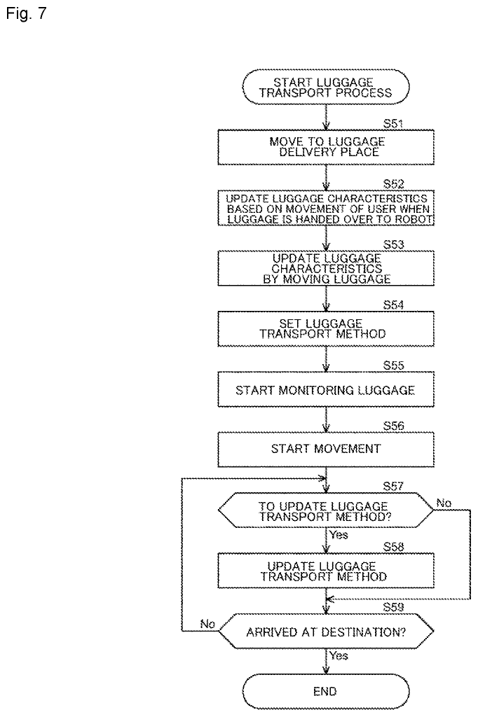

Returning to FIG. 7, in step S54, the transport method setting unit 283 sets the luggage transport method based on the luggage characteristics. For example, the transport method setting unit 283 sets at least one of the movement method and the transport route of the robot 12 based on at least one of the fragility coefficient, the packaging quality coefficient, the resonance frequency of the luggage, and the position of the sound source of the generated sound.

For example, the transport method setting unit 283 sets at least one of the movement method and the transport route of the robot 12 based on the transport method setting unit, the fragility coefficient, and the packaging quality coefficient in consideration of the balance between the time required to reach the destination (hereinafter referred to as transport time) and the safety against damage to the luggage.

For example, when the transport method setting unit 283 determines that the content of the luggage is not easily fragile and the packaging quality is good based on the fragility coefficient and the packaging quality coefficient, the transport method setting unit 283 sets at least one of the movement method and the transport route of the robot 12 by giving priority to shortening the transport time.

Specifically, for example, the transport method setting unit 283 sets the movement method of the robot 12 so as to satisfy at least one of the following conditions in order to increase the speed and acceleration of the robot 12.
Raise the knee of the robot 12 high.
Increase the stride length of the robot 12.
Alternately move the pair of legs 202FL and 202BL (left legs) of the robot 12 and the pair of legs 202FR and 202BR (right legs).
Move barefoot without attaching wheels to the legs 202 of the robot 12.
Weaken the impact absorption capacity of the dampers of each leg 202 of the robot 12 (soften the dampers).
Do not slow down as much as possible around objects (for example, people, vehicles, and the like) that may cause the robot 12 to stop suddenly.
Jump over obstacles as much as possible.

For example, the transport method setting unit 283 sets the transport route of the robot 12 to the shortest possible route.

On the other hand, for example, when the transport method setting unit 283 determines that the content of the luggage are fragile or the packaging quality is not good based on the fragility coefficient and the luggage quality coefficient, the transport method setting unit 283 sets at least one of the movement method and the transport route of the robot 12 by giving priority to safety against damage to the luggage.

For example, the transport method setting unit 283 sets the movement method of the robot 12 so as to satisfy at least one of the following conditions in order to keep the impact and vibration applied to the luggage during transportation within an allowable range.
Raise the knee of the robot 12 low.
Reduce the stride length of the robot 12.
Move each leg 202 of the robot 12 one by one.
Attach wheels to each leg 202 of the robot 12.
Strengthen the impact absorption capacity of dampers of each leg 202 of the robot 12 (harden the dampers).
Slow down around objects (for example, people, vehicles, and the like) that may cause the robot 12 to stop suddenly.
Avoid obstacles without jumping over them.

For example, the transport method setting unit 283 sets the movement method of the robot 12 based on the resonance frequency of the luggage. That is, the transport method setting unit 283 sets such a movement method that vibration near the resonance frequency is not applied to the luggage.

For example, the transport method setting unit 283 sets the movement method of the robot 12 based on the position of the sound source of the generated sound.

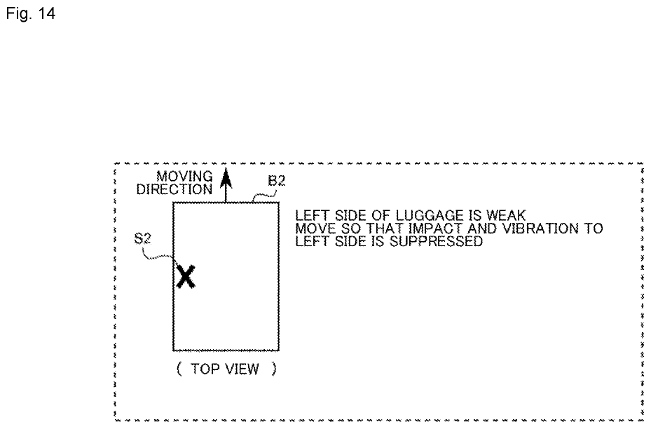

Here, with reference to FIGS. 14 to 17, a method of setting the movement method of the robot 12 based on the position of the sound source of the generated sound will be described.

FIG. 14 is a view of the luggage B2 as viewed from above, and the sound source S2 is located near the left end of the luggage B2. In this case, it is estimated that the content of the luggage B2 is present near the position of the sound source S2 and the left side of the luggage B2 is weak. Therefore, the movement method of the robot 12 is set so that the impact and vibration to the left side of the luggage B2 are suppressed.

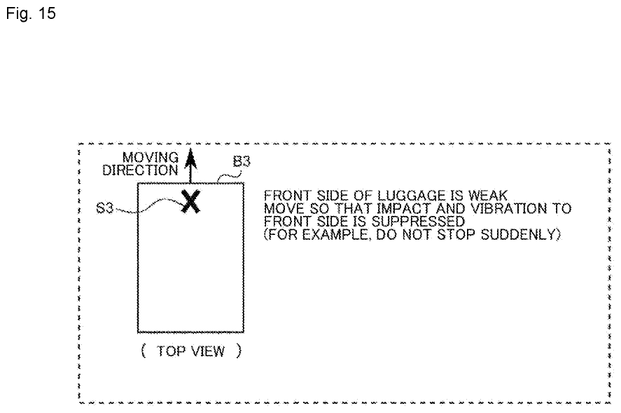

FIG. 15 is a view of the luggage B3 as viewed from above, and the sound source S3 is present near the front end of the luggage B3. In this case, it is estimated that the content of the luggage B3 is present near the position of the sound source S3 and the front side of the luggage B3 is weak. Therefore, the movement method of the robot 12 is set so as to suppress the impact and vibration to the front side of the luggage B3. For example, the movement method of the robot 12 is set so that the robot 12 does not stop suddenly.

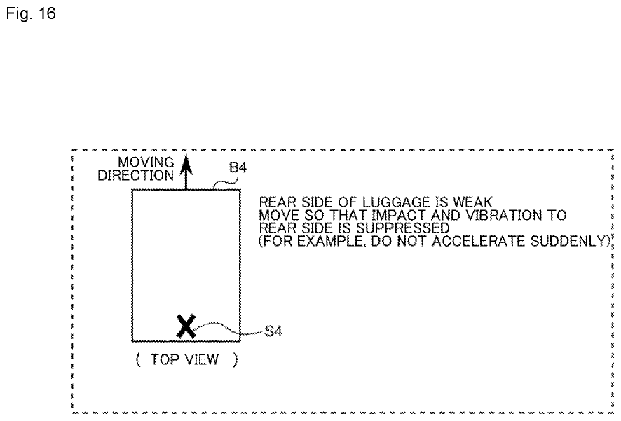

FIG. 16 is a view of the luggage B4 as viewed from above, and the sound source S4 is present near the front end of the luggage B4. In this case, it is estimated that the content of the luggage B4 is present near the position of the sound source S4 and the back side of the luggage B4 is weak. Therefore, the movement method of the robot 12 is set so as to suppress the impact and vibration to the rear side of the luggage B4. For example, the movement method of the robot 12 is set so that the robot 12 does not accelerate suddenly.

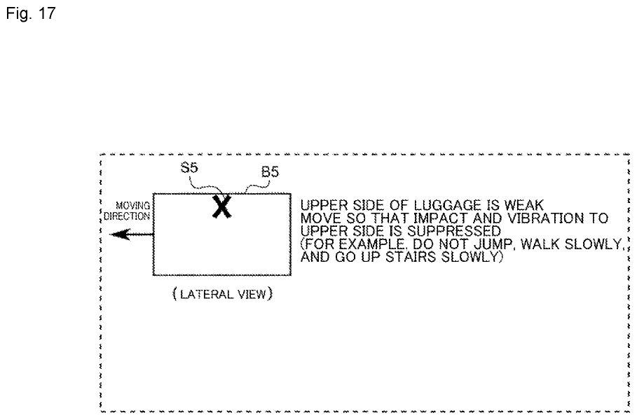

FIG. 17 is a side view of the luggage B5, and the sound source S5 is present near the upper end of the luggage B5. In this case, it is estimated that the content of the luggage B5 is present near the position of the sound source S5 and the upper side of the luggage B5 is weak. Therefore, the movement method of the robot 12 is set so that the impact and vibration on the upper side of the luggage B5 are suppressed. For example, the movement method of the robot 12 is set so that the robot 12 does not jump. For example, the movement method of the robot 12 is set so that the robot 12 walks at a low speed. For example, the movement method of the robot 12 is set so that the robot 12 goes up and down the stairs at a low speed.

For example, the transport method setting unit 283 sets the transport route of the robot 12 so as to satisfy at least one of the following conditions in order to keep the impact and vibration applied to the luggage during transportation within an allowable range.
Avoid moving up and down steep slopes and stairs as much as possible.
Avoid places with many obstacles (for example, crowded places and places with heavy traffic) as much as possible.
Avoid rough roads (for example, unpaved roads) as much as possible.

In this way, the method of transporting the luggage is set.

In step S55, the robot 12 starts monitoring the luggage. Specifically, the luggage characteristic estimation unit 282 starts the process of detecting the change in the position of the center of gravity of the luggage due to the movement of the luggage during transportation, the vibration characteristics of the luggage, and the characteristics of the sound generated by the luggage based on the image data from the camera 257 and the sensor data from the sensing unit 258 by the same processing as in step S53 described above. The luggage characteristic estimation unit 282 starts a process of appropriately updating the luggage characteristics based on the detection result by the same process as in step S53 described above.

In step S56, the robot 12 starts moving. Specifically, the operation control unit 284 starts a process of controlling the drive unit 259 so that the robot 12 moves to the destination according to the transport method set by the transport method setting unit 283.

In step S57, the transport method setting unit 283 determines whether or not to change the luggage transport method. For example, if the luggage characteristics are significantly changed by the luggage characteristic estimation unit 282 and it is desirable to change the luggage transport method, the transport method setting unit 283 determines that the luggage transport method is to be changed, and the process proceeds to step S58.

In step S58, the robot 12 changes the method of transporting the luggage. Specifically, the transport method setting unit 283 resets the luggage transport method based on the luggage characteristics and the like by the same process as in step S54. As a result, the method of transporting luggage is changed.

The operation control unit 284 starts a process of controlling the drive unit 259 so that the robot 12 moves to the destination according to the changed transport method.

Thereafter, the processing proceeds to step S59.

On the other hand, if it is determined in step S57 that the method of transporting the luggage is not to be changed, the process of step S58 is skipped and the process proceeds to step S59.

In step S59, the operation control unit 284 determines whether or not the robot has arrived at the destination. If it is determined that the robot has not arrived at the destination, the process returns to step S57.

After that, in step S59, the processes of steps S57 to S59 are repeatedly executed until it is determined that the robot has arrived at the destination. That is, the robot 12 monitors the luggage, updates the luggage characteristics as appropriate, and transports the luggage to the destination while changing the transport method as necessary.

On the other hand, if it is determined in step S59 that the robot has arrived at the destination, the luggage transport process ends.

As described above, the luggage characteristics including the fragility of the content of the luggage and the packaging quality can be accurately estimated without unpackaging the luggage. As a result, it is possible to prevent damage to the content of the luggage during transportation.

Further, an appropriate transport method, that is, a movement method and a transport route, is set based on the luggage characteristics. As a result, damage to the content of the luggage during transportation can be prevented, and the luggage can be transported in an appropriate transport time.

### 2. Modification Examples

Hereinafter, modification examples of the above-described embodiment of the present technology will be explained.

### Modification Example of Robot 12

For example, the robot 12 may execute a part or all of the processing of the information processing device 11. For example, the robot 12 may estimate the luggage characteristics based on the luggage information acquired from the user terminal 13. The robot 12 may select the robot 12 to be dispatched based on the estimated luggage characteristics.

For example, the information processing device 11 may execute a part of the processing of the robot 12. For example, the information processing device 11 may estimate and update the luggage characteristics based on the image data from the camera 257 and the sensor data from the sensing unit 258.

For example, the information processing device 11 may set the luggage transport method based on the luggage characteristics and instruct the robot 12 on the transport method. In this case, the information processing device 11 remotely controls the robot 12.

For example, the robot 12 may search for a more suitable robot 12 based on the luggage characteristics so as to take over the transportation of the luggage while the luggage is being transported.

For example, a pressure distribution sensor may be used instead of the force sensor 205.

### Modification Examples of Machine Learning

For example, machine learning may be used for the luggage characteristic estimation process and the luggage transport method setting process.

For example, a classifier is generated by machine learning using training data which uses at least one of at least a part of the above-mentioned luggage information, the amount of change in the position of the center of gravity due to the movement of the luggage, the vibration characteristics of the luggage, and the characteristics of the sound generated by the luggage as input data, and at least a part of the luggage characteristics as correct data. Then, the luggage characteristic estimation unit 282 may estimate the luggage characteristic using the generated classifier.

For example, a classifier is generated by machine learning using training data which uses at least one of at least a part of the above-mentioned luggage information, the amount of change in the position of the center of gravity due to the movement of the luggage, the vibration characteristics of the luggage, and the characteristics of the sound generated by the luggage as input data. Then, the transport method setting unit 283 may set the transport method using the generated classifier. In this case, for example, the transport method setting unit 283 can omit the luggage characteristic estimation process and directly set the transport method based on the same type of data as the input data of machine learning.

The robot 12 may be provided with a learning unit that performs machine learning so as to performing learning of the luggage characteristic estimation process and the luggage transport method setting process based on the result of actually transporting the luggage.

### Other Modification Examples

For example, it is possible to omit the luggage characteristic estimation process based on the luggage information acquired in advance and the luggage characteristic estimation process based on the user's movement.

For example, it is possible to omit the process of updating the luggage characteristics and the process of changing the transport method during transportation. That is, the transport method may not be changed during transportation.

For example, it is possible to omit the process of moving the luggage and updating the luggage characteristics before transportation. For example, the luggage characteristics may be estimated and the transport method may be set based on the luggage information acquired in advance, and then the luggage characteristics may be updated and the transport method may be changed during the transportation of the luggage.

### Application Example of Present Technology

In addition to the robots described above, the present technology can be applied to autonomous moving bodies (for example, automated driving vehicles, luggage carriers, and the like) that can move autonomously and transport luggage. In addition to land, the present technology can also be applied to autonomous moving bodies (for example, drones, and the like) that move autonomously in the air, on the water, in the water, and underground.

The present technology can be applied to any of an autonomous moving body that moves in a public place and an autonomous moving body that moves within a predetermined range (for example, in a factory, in a warehouse, and the like).

Furthermore, the present technology can be applied to transport devices (for example, robot arms and the like) other than autonomous moving objects, such as transport devices that do not move by themselves but can operate autonomously and transport luggage. In this case, for example, as a transport method, an operation method of the transport device is set instead of the movement method and the transport route.

### 3. Others

The above-described series of processing can also be performed by hardware or software.

The program executed by a computer may be a program that performs processing chronologically in the order described in the present specification or may be a program that performs processing in parallel or at a necessary timing such as a called time.

In addition, in the present specification, a system means a collection of a plurality of constituent elements (devices, modules (components), or the like) and whether all the constituent elements are contained in the same casing does not matter. Accordingly, a plurality of devices accommodated in separate casings and connected via a network and one device in which a plurality of modules are accommodated in one casing are all systems.

Embodiments of the present technology are not limited to the above-described embodiments and can be changed variously within the scope of the present technology without departing from the gist of the present technology.

For example, the present technology may be configured as cloud computing in which a plurality of devices share and cooperatively process one function via a network.

In addition, each step described in the above flowchart can be executed by one device or executed in a shared manner by a plurality of devices.

Furthermore, in a case in which one step includes a plurality of processes, the plurality of processes included in the one step can be executed by one device or executed in a shared manner by a plurality of devices.

### Combination Example of Configuration

The present technology can also have the following configuration.

(1) A transport device including: a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

(2) The transport device according to (1), further including a transport method setting unit that sets a transport method for the luggage based on the luggage characteristics.

(3) The transport device according to (2), further including an operation control unit that controls an operation of the transport device based on the set transport method.

(4) The transport device according to (3), wherein the operation control unit moves the luggage by controlling the operation of the transport device when the luggage characteristic estimation unit estimates the luggage characteristics.

(5) The transport device according to (4), wherein the luggage characteristic estimation unit estimates the luggage characteristics before transporting the luggage, and the transport method setting unit sets the transport method before transporting the luggage based on the estimated luggage characteristics.

(6) The transport device according to (4) or (5), wherein the luggage characteristic estimation unit estimates the luggage characteristics based on at least one of the change in the position of the center of gravity when the luggage is moved, the vibration characteristics of the luggage, and the characteristics of the generated sound, and information on the luggage acquired in advance.

(7) The transport device according to any one of (4) to (6), wherein the operation control unit controls the operation of the transport device so as to gradually increase at least one of speed, strength, and magnitude of moving the luggage.

(8) The transport device according to any one of (3) to (7), wherein the luggage characteristic estimation unit estimates the luggage characteristics based on at least one of the change in the position of the center of gravity of the luggage during transportation of the luggage, the vibration characteristics of the luggage, and the characteristics of the generated sound, and the transport method setting unit changes the transport method during transportation of the luggage based on the estimated luggage characteristics.

(9) The transport device according to any one of (2) to (8), wherein the transport device is an autonomous moving body, and the transport method setting unit sets at least one of a movement method and a transport route of the transport device.

(10) The transport device according to (9), wherein the luggage characteristics include a position of a sound source of the generated sound, and the transport method setting unit sets at least one of the movement method and the transport route of the transport device further based on the position of the sound source of the generated sound.

(11) The transport device according to (9) or (10), wherein the luggage characteristics include a resonance frequency of the luggage, and the transport method setting unit sets at least one of the movement method and the transport route of the transport device further based on the resonance frequency of the luggage.

(12) The transport device according to any one of (2) to (11), wherein the transport method setting unit sets the transport method using a classifier obtained by machine learning which uses training data including input data including at least one of an amount of change in the position of the center of gravity due to the movement of the luggage, the vibration characteristics of the luggage, and the characteristics of the generated sound of the luggage.

(13) The transport device according to any one of (1) to (12), wherein the luggage characteristic estimation unit estimates the packaging quality based on an amount of change in the position of the center of gravity when the luggage is tilted.

(14) The transport device according to any one of (1) to (13), wherein the luggage characteristic estimation unit estimates the luggage characteristics based on at least one of a frequency, an amplitude, and a duration of vibration of the luggage when the luggage is vibrated.

(15) The transport device according to any one of (1) to (14), wherein the luggage characteristic estimation unit estimates the luggage characteristics based on at least one of a frequency, an amplitude, and a duration of the generated sound.

(16) The transport device according to any one of (1) to (15), further including a recognition unit that recognizes movement of a user when handling the luggage, wherein the luggage characteristic estimation unit estimates the luggage characteristics further based on the recognized movement of the user.

(17) The transport device according to any one of (1) to (16), wherein the luggage characteristic estimation unit estimates the luggage characteristics using a classifier obtained by machine learning which uses training data including input data including at least one of an amount of change in the position of the center of gravity due to the movement of the luggage, the vibration characteristics of the luggage, and the characteristics of the generated sound of the luggage, and answer data including the luggage characteristics.

(18) A transport method including: allowing a transport device to estimate luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

(19) A program for causing a computer to execute processing including: estimating luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

(20) An information processing device including: a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

The advantageous effects described in the present specification are merely exemplary and are not limited, and other advantageous effects may be obtained.

### REFERENCE SIGNS LIST

1 Information processing system

11 Information processing device

12-1 to 12-m Robot

13-1 to 13-m User terminal

101 CPU

121 Luggage characteristic estimation unit

122 Robot selection unit

201 Body

202FL to 202BR Leg

203 Acceleration sensor

204FL to 204BR Microphone

205FL to 205BR Force sensor

251 CPU

257 Camera

258 Sensing unit

259 Drive unit

281 Recognition unit

282 Luggage characteristic estimation unit

283 Transport method setting unit

284 Operation control unit

1. A transport device comprising:
a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

2. The transport device according to claim 1, further comprising a transport method setting unit that sets a transport method for the luggage based on the luggage characteristics.

3. The transport device according to claim 2, further comprising an operation control unit that controls an operation of the transport device based on the set transport method.

4. The transport device according to claim 3, wherein
the operation control unit moves the luggage by controlling the operation of the transport device when the luggage characteristic estimation unit estimates the luggage characteristics.

5. The transport device according to claim 4, wherein
the luggage characteristic estimation unit estimates the luggage characteristics before transporting the luggage, and
the transport method setting unit sets the transport method before transporting the luggage based on the estimated luggage characteristics.

6. The transport device according to claim 4, wherein
the luggage characteristic estimation unit estimates the luggage characteristics based on at least one of the change in the position of the center of gravity when the luggage is moved, the vibration characteristics of the luggage, and the characteristics of the generated sound, and information on the luggage acquired in advance.

7. The transport device according to claim 4, wherein
the operation control unit controls the operation of the transport device so as to gradually increase at least one of speed, strength, and magnitude of moving the luggage.

8. The transport device according to claim 3, wherein
the luggage characteristic estimation unit estimates the luggage characteristics based on at least one of the change in the position of the center of gravity of the luggage during transportation of the luggage, the vibration characteristics of the luggage, and the characteristics of the generated sound, and
the transport method setting unit changes the transport method during transportation of the luggage based on the estimated luggage characteristics.

9. The transport device according to claim 2, wherein
the transport device is an autonomous moving body, and
the transport method setting unit sets at least one of a movement method and a transport route of the transport device based on the luggage characteristics.

10. The transport device according to claim 9, wherein
the luggage characteristics include a position of a sound source of the generated sound, and
the transport method setting unit sets at least one of the movement method and the transport route of the transport device further based on the position of the sound source of the generated sound.

11. The transport device according to claim 9, wherein
the luggage characteristics include a resonance frequency of the luggage, and the transport method setting unit sets at least one of the movement method and the transport route of the transport device further based on the resonance frequency of the luggage.

12. The transport device according to claim 2, wherein
the transport method setting unit sets the transport method using a classifier obtained by machine learning which uses training data including input data including at least one of an amount of change in the position of the center of gravity due to the movement of the luggage, the vibration characteristics of the luggage, and the characteristics of the generated sound of the luggage.

13. The transport device according to claim 1, wherein
the luggage characteristic estimation unit estimates the packaging quality based on an amount of change in the position of the center of gravity when the luggage is tilted.

14. The transport device according to claim 1, wherein
the luggage characteristic estimation unit estimates the luggage characteristics based on at least one of a frequency, an amplitude, and a duration of vibration of the luggage when the luggage is vibrated.

15. The transport device according to claim 1, wherein
the luggage characteristic estimation unit estimates the luggage characteristics based on at least one of a frequency, an amplitude, and a duration of the generated sound.

16. The transport device according to claim 1, further comprising a recognition unit that recognizes movement of a user when handling the luggage, wherein
the luggage characteristic estimation unit estimates the luggage characteristics further based on the recognized movement of the user.

17. The transport device according to claim 1, wherein
the luggage characteristic estimation unit estimates the luggage characteristics using a classifier obtained by machine learning which uses training data including input data including at least one of an amount of change in the position of the center of gravity due to the movement of the luggage, the vibration characteristics of the luggage, and the characteristics of the generated sound of the luggage, and answer data including the luggage characteristics.

18. A transport method comprising:
allowing a transport device to estimate luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

19. A program for causing a computer to execute processing comprising:
estimating luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.

20. An information processing device comprising:
a luggage characteristic estimation unit that estimates luggage characteristics including at least one of fragility of a content of luggage and packaging quality of the luggage based on at least one of change in center of gravity due to movement of the luggage, vibration characteristics of the luggage, and characteristics of the sound generated from the luggage due to the movement of the luggage.
